(19) United States
(12) Patent Application Publication
(10) Pub. No.: US 2008/0253476 A1
(43) Pub. Date: Oct. 16, 2008

(54) Method and System for Enabling Collusion Resistant Watermarking

(75) Inventors: Aweke Negash Lemma, Eindhoven (NL); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/066,685

(22) PCT Filed: Sep. 12, 2006
(86) PCT No.: PCT/IB06/53221

§ 371 Date: Mar. 13, 2008

(30) Foreign Application Priority Data
Sep. 16, 2005 (EP) 05108522.3

(51) Int. Cl. H04L 25/49

(52) U.S. Cl. 375/296

(57) ABSTRACT

A method and a system for modifying a bitstream signal for enabling collusion resistant bitstream watermarking. The method comprises dividing a bitstream spectral signal X[k] of the bitstream signal bx into a first signal (302) and a second signal (304); multiplying the first signal (302) by a first modification signal (306) and outputting a modified first signal (314); performing a transform operation on said second signal (304) for obtaining a transformed second signal (308); multiplying said transformed second signal (308) by a second modification signal (310) and outputting a second modified signal (312); subtracting said second modified signal (312) from said first modified signal (314) and outputting a modified bitstream spectral signal X′[k] suitable for obtaining a modified bitstream signal b′x of said bitstream signal bx. Thus an efficient manner of applying a collusion resistant property for already encoded contents is provided.

### FIELD OF THE INVENTION

This invention pertains in general to the field of secure transmission of data. More particularly the invention relates to a method and arrangement for efficient collusion resistant compressed domain watermarking and more particularly to modifying a bitstream signal for enabling collusion resistant bitstream watermarking.

### BACKGROUND OF THE INVENTION

In watermarking systems, people are faced with the reality that hackers may try to remove a watermark to obtain valuable and unprotected content. Thus it is desirable to devise methods for improving the watermark resistance to different forms of attacks. One such form of attack is the so-called collusion attack. It is an attack in which the attacker has access to more than one watermarked signals. There are two types of collusion attacks, in which the attacker has access to 1) different signals with the same watermark (typically occurring in copy protection-like systems), and 2) multiple identical signals with different watermarks (this typically occurs in electronic content delivery systems).

The first type is relatively straight forward. Using an averaging operation, the watermark can be estimated and eventually removed. There are known solutions to this problem. For example, methods such as the one described in “Watermarking and Fingerprinting for Electronic Music Delivery” by Michiel van der Veen, Aweke Lemma and Ton Kalker, SPIE Workshop 2004, San Jose, Calif., USA, can be used to embed content dependent watermarks in signals thereby making it difficult to estimate the watermark via simple averaging.

For the second type collusion attack, however, the solution of content dependent watermarks cannot be used, and simple averaging will remove the watermark energy. Several solutions to this collusion threat have been proposed. For example, U.S. Pat. No. 6,145,081 discloses one such method based on phase modulation. The idea is to modify the phase of the watermarked signal in such a way that averaging the host will lead to a degraded version of the host signal itself. The phase modulation is designed in such a manner that phase cancellation occurs and annoying artifacts are introduced. The patent provides two solutions worked out in the base-band domain. Although the concept of U.S. Pat. No. 6,145,081 is straight forward, the short comings of the approach become apparent when applied to a bitstream signal. This solution would require the decoding of the signal followed by phase modulation followed by watermark embedding followed by re-encoding of the signal.

A different solution to the collusion attack is presented in U.S. Pat. No. 5,664,018. This solution is based on randomization of a base-line (reference) watermark. The idea is to put enough similar redundancy into the different watermark signals such that at least a portion of the watermark survives the collusion attack. One problem with this approach is the penalty on the payload capacity due to the extra space needed to carry the redundant information. In some applications such as Electronic Music Distribution (EMD), such a penalty on the payload capacity can be unacceptable. Another problem with this approach is that the uniqueness of the payload is lost during collusion attack, i.e. the payload can no longer be identified uniquely. This is a major drawback for instance for forensic tracking applications.

Another proposed method separates the embedded signal into so-called private and global watermarks, each with its own payload. After averaging, the private watermark energy is reduced but the global watermark remains intact. A potential drawback for this solution is the reduction in payload capacity. Also, the uniqueness of the payload is lost after a collusion attack, when using this approach with private and global watermarks.

Another solution directed toward the bitstream content is proposed in yet unpublished European patent application 05102889.2 of same applicant filed on 13 Apr. 2005 (applicant's docket no. PHNL050272), which is incorporated herein by reference. The method finds an efficient way of embedding a collusion-protected watermark by means of efficient phase modulation where partial decoding and encoding is performed. In one specific realization of the invention of PHNL050272, the bitstream data undergoes partial decoding and the so-called IMDCT (Inverse Modified Discrete Cosine Transform)/MDCT (Modified Discrete Cosine Transform) transformations. However, transformation of the content can be prohibitive in applications where fast bitstream-to-bitstream processing is required. This is the case when watermark embedding has already taken place prior to the creation of the bitstream or when embedding is performed completely in the bitstream domain. The method described in PHNL050272 is hence not sufficiently efficient in applications where fast bitstream watermark embedding is required, such as forensic tracking applications where watermarks are embedded on the fly during download or client side bit stream watermarking on cheap consumer devices is required.

Hence, an improved method for embedding collusion resistant watermarks would be advantageous and in particular a method and system allowing for collusion protection without affecting the payload capacity of the watermark signal and without the need for partial decoding, for instance IMDCT-MDCT cascaded transformations, would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems, at least partly, by providing a device, a method, and a computer-readable medium that efficiently provides for collusion resistant compressed-domain watermarking, according to the appended patent claims.

The general solution according to the invention provides a framework for modifying a bitstream signal for producing collusion resistant bitstream watermarking. According to aspects of the invention, a method, a system, and a computer-readable medium for modifying a bitstream signal for enabling collusion resistant bitstream watermarking are disclosed.

According to one aspect of the invention, a method is provided for modifying a bitstream signal for enabling collusion resistant bitstream watermarking thereof. The method comprises: dividing a bitstream spectral signal of said bitstream signal into a first signal and a second signal; multiplying the first signal by a first modification signal and outputting a first modified signal; performing a transform operation on said second signal for obtaining a transformed second signal; multiplying said transformed second signal by a second modification signal and outputting a modified second signal; and subtracting said second modified signal from said first modified signal and outputting a modified bitstream spectral signal suitable for obtaining a modified bitstream signal of said bitstream signal.

According to another aspect of the invention, a system is provided for modifying a bitstream signal for enabling collusion resistant bitstream watermarking thereof. The system comprises: means for dividing a bitstream spectral signal of said bitstream signal into a first signal and a second signal; means for multiplying the first signal by a first modification signal and outputting a modified first signal; means for performing a transform operation on said second signal for obtaining a transformed second signal; means for multiplying said transformed second signal by a second modification signal and outputting a second modified signal; means for subtracting said second modified signal from said first modified signal and outputting a modified bitstream spectral signal suitable for obtaining a modified bitstream signal of said bitstream signal.

According to a further aspect of the invention, a computer-readable medium having embodied thereon a computer program for enabling a bitstream signal for producing collusion resistant bitstream watermarking thereof, for processing by a computer is provided. The computer program comprises: a first code segment for dividing a bitstream spectral signal of said bitstream signal into a first signal and a second signal; a second code segment for multiplying the first signal by a first modification signal and outputting a first modified signal; a third code segment for performing a transform operation on said second signal for obtaining a transformed second signal; a fourth code segment for multiplying said transformed second signal by a second modification signal and outputting a second modified signal; and a fifth code segment for subtracting said second modified signal from said first modified signal and outputting a modified bitstream spectral signal suitable for obtaining a modified bitstream signal of said bitstream signal.

The present invention has at least the advantage over the prior art that it provides an efficient manner of applying a collusion resistant property for already encoded contents. Another advantage is that system complexity is significantly reduced by eliminating the need for (at least partial) decoding and encoding.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a schematic diagram of a system for providing the collusion protection where the watermark is a priori embedded in a bitstream according to one embodiment of the invention;

FIG. 2 is a schematic diagram of a system for providing the collusion protection where the watermark signal is embedded in the bitstream according to one embodiment of the invention;

FIG. 3 is a schematic diagram of a bitstream modification unit according to one embodiment of the invention;

FIG. 4 is a flow chart illustrating the operation of the bitstream modification unit according to one embodiment of the invention; and

FIG. 5 is a schematic diagram of a computer readable medium for providing collusion protection according to one embodiment of the invention.

### DESCRIPTION OF EMBODIMENTS

The following description focuses on embodiments of the present invention applicable to Advanced Audio Coding (AAC) audio compression format signals. However, it will be appreciated that the invention is not limited to this application but may be applied to any other compressed format, MPEG video, WMV, or MP3 audio, etc. Thus, the invention pertains to many emerging applications such as electronic music delivery, video-on-demand system, p2p file sharing services with integrated watermark solutions, etc.

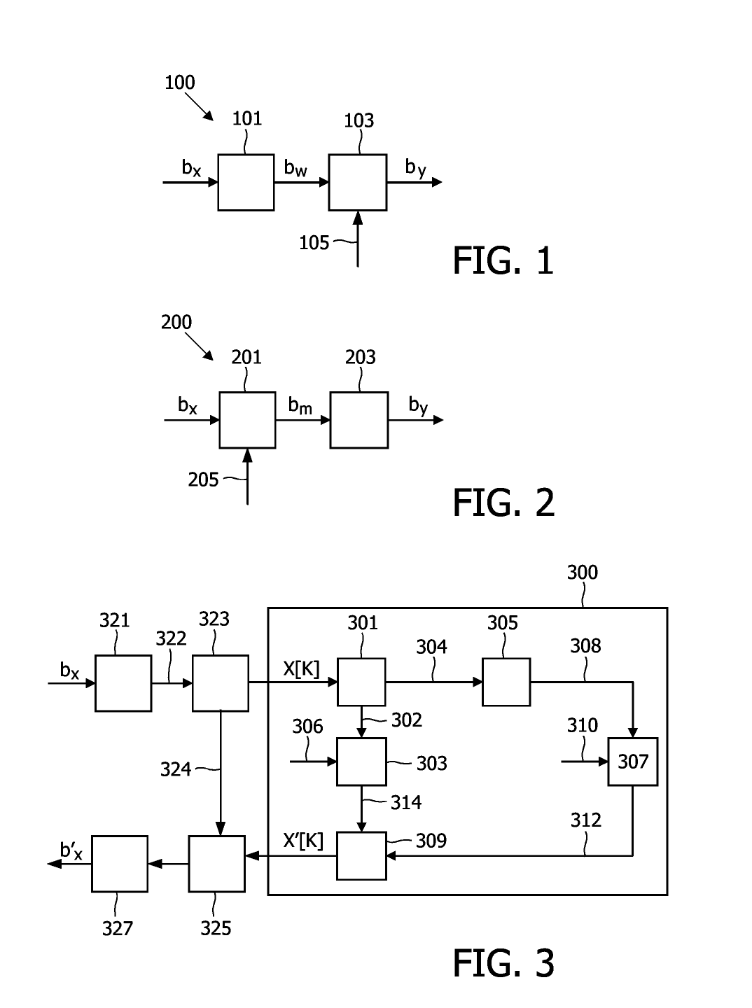

A basic idea of the invention is to generate bitstream modified signals in such a way that averaging the decoded version of the bitstream modified signals will inevitably lead to phase distortions and perceptual degradation. A bitstream method for preventing collusion attacks for already watermarked bitstream signals or for signals that are embedded in the bitstream domain is disclosed. These two ideas are schematically illustrated in FIGS. 1-2.

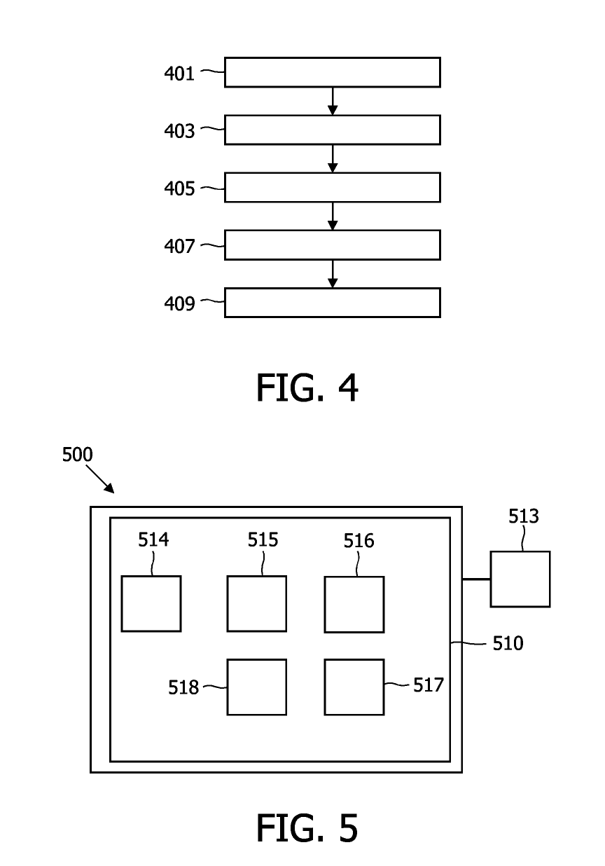

FIG. 1 illustrates a system 100 for providing the collusion protection where the watermark is a priori embedded. The watermark is embedded into an input bitstream signal bₓ using a bitstream watermark embedder unit 101 in a known manner. The watermarked bitstream signal b_{w} is then modified by a bitstream modification unit 103 to produce a watermarked collusion resistant bitstream signal b_{y}. The operation of the bitstream modification unit 103 will be explained in more detail below with reference to FIGS. 3-4.

FIG. 2 illustrates a system 200 for providing the collusion protection where the watermark signal is embedded in the bitstream after modification of the bitstream. An input bitstream signal bₓ is first modified by a bitstream modification unit 201 into a modified bitstream signal bₘ. Subsequently a watermark is embedded into the modified bitstream signal bₘ by a bitstream watermark embedder 203 to produce a watermarked collusion resistant bitstream signal b_{y}. Operation of bitstream modification unit 201 or bitstream modification unit 103 is controllable by a control signal 205 or 105, respectively.

The method for preventing collusion is based on generating phase modified (clear text) signals in such a way that averaging them will lead to phase distortions and perceptual degradation, thus rendering the content useless. According to the invention, the phase modulation is implemented entirely in the bitstream domain such that any attempt to collude multiple clear text contents derived from so modified bitstream signals for the purpose of removing the watermark will result in highly degraded content.

According to one embodiment of the invention, the following mathematical operations show what specific modifications are performed in the transform domain such that collusion resistant property is achieved. For this, it is important to note that the phase of the signal varies slowly enough that the introduced delay can be assumed to be constant in a given DCT frame. To be specific, consider a frame time domain signal x[n]. Its MDCT is then given by

$$X [ k ] = {\sum }_{n = 0}^{N - 1} f [ n ] x [ n ] cos ( \frac{π}{2 N} ( 2 n + 1 + \frac{N}{2} ) ( 2 k + 1 ) ) \qquad ( 1 )$$

where n=0, . . . , N−1, and

$$k = 0 , … , \frac{N}{2} - 1.$$

Where f[n] is a window function with some required properties. For example, the sine function shown below satisfies these properties:

$$f [ n ] = sin ( π \frac{n}{N} ) \qquad ( 2 )$$

Now assume that the MDCT is applied to the phase modified signal x[n−τ] instead of x[n]. Then equation (1) becomes

$${X}_{τ} [ k ] = {\sum }_{n = 0}^{N - 1} f [ n ] x [ n - τ ] cos ( \frac{π}{2 N} ( 2 n + 1 + \frac{N}{2} ) ( 2 k + 1 ) ) , \\ k = 0 , … , \frac{N}{2} - 1 \qquad ( 3 )$$

Now, applying change of variable, i.e., n−τ=m, equation (4) is obtained:

$${X}_{τ} [ k ] = {\sum }_{n = 0}^{N - τ - 1} f [ m + τ ] x [ m ] cos ( \frac{π}{2 N} ( 2 m + 2 τ + 1 + \frac{N}{2} ) ( 2 k + 1 ) ) , \\ k = 0 , … , \frac{N}{2} - 1 \qquad ( 4 )$$

Elaborating further by applying the identity cos(x+y)=cos(x)cos(y)−sin(x)sin(y), the following equivalent representation is obtained:

$${X}_{τ} [ k ] = cos ( \frac{π}{N} ( 2 k + 1 ) τ ) {\sum }_{m = - τ}^{N - τ - 1} f [ m + τ ] x [ m ] cos ( \frac{π}{2 N} ( 2 m + 1 + \frac{N}{2} ) ( 2 k + 1 ) ) - sin ( \frac{π}{N} ( 2 k + 1 ) τ ) {\sum }_{m = - τ}^{N - τ - 1} f [ m + τ ] x [ m ] sin ( \frac{π}{2 N} ( 2 m + 1 + \frac{N}{2} ) ( 2 k + 1 ) ) \qquad ( 5 )$$

where k takes value ranges shown in equation (4). Note that the second part of the first term on the right side of equation (5) is the same as X[k] and the second part of the second term is equal to H{X[k]}, where H{ } stands for the Hilbert transform. Thus, equation (5) can be simplified as

$${X}_{τ [ k ] =} cos ( \frac{π}{N} ( 2 k + 1 ) τ ) X [ k ] - sin ( \frac{π}{N} ( 2 k + 1 ) τ ) H \{ X [ k ] \}$$

This means that the modification in the temporal domain is a combination of multiplication and Hilbert transform in the Discrete Cosine Transform (DCT) domain. One way of implementing the modification is illustrated in FIGS. 3-4. FIG. 3 illustrates a bitstream modification unit 300 comprising a signal splitter 301, multiplication units 303, 307, a Hilbert transform unit 305 and a subtraction unit 309. FIG. 3 illustrates also how the input bitstream input signal bₓ is related to bitstream spectral signal X[k]. Signal bₓ is treated in a parser 321 and the resulting parsed bitstream signal 322 passed to a Demultiplexing (DeMUX) unit 323, where header and related side information 324 from the parsed signal 322 is extracted, and the remaining signal is the input bitstream spectral signal X[k]. The operation of the bitstream modification unit 300 will now be explained with reference to FIG. 4. In step 401, the input bitstream spectral signal X[k] (spectral data), input into bitstream modification unit 300, is split into a first signal 302 and second signal 304 by a splitter 301. The first signal 302 is then multiplied by a first modification signal 306 in the multiplication unit 303 in step 403 in order to obtain a first modified signal 314. In this particular embodiment, where AAC bitstream is considered, the first modification signal 306 is

$$cos ( \frac{π}{N} ( 2 k + 1 ) τ ) .$$

The second signal 304 is sent to a transform unit 305. In this particular embodiment, where AAC bitstream is considered, the transform unit 305 performs a Hilbert transform operation on the second signal in step 405. The transformed signal 308 is then sent to the multiplication unit 307. The multiplication unit 307 multiplies the transformed signal 308 by a second modification signal 310 in step 407 in order to obtain a second modified signal 312. In this particular embodiment, where AAC bitstream is considered, the second modification signal 310 is

$$sin ( \frac{π}{N} ( 2 k + 1 ) τ ) .$$

In step 409, the second modified signal 312 is then subtracted from the first modified signal 314 in the subtraction unit 309 to produce a collusion resistant bitstream spectral signal X′[k], output from bitstream modification unit 300. The collusion resistant bitstream spectral signal X′[k] is then multiplexed with header information 324 in a Multiplex (MUX) unit 325, passed along a packer unit 327, resulting in a modified collusion resistant bitstream signal b′ₓ. According to certain embodiments, this modified collusion resistant bitstream signal b′ₓ is either equal to watermarked collusion resistant bitstream signal b_{y} (see FIG. 1) or equal to modified bitstream signal bₘ (FIG. 2) to be watermarked in order to give a watermarked collusion resistant bitstream signal b_{y}.

In another embodiment of the invention according to FIG. 5, a computer readable medium is illustrated schematically. A computer-readable medium 500 has embodied thereon a computer program 510 for embedding a watermark in a media signal in a device, for processing by a computer 513. The computer program 510 comprises a first code segment 514 for dividing a bitstream signal into a first signal and a second signal; a second code segment 515 for multiplying the first signal by a first modification signal and outputting a first modified signal; a third code segment 516 for performing a transform operation on said second signal; a fourth code segment 517 for multiplying said transformed second signal by a second modification signal and outputting a second modified signal; a fifth code segment 518 for subtracting said second modified signal from said first modified signal and outputting a modified bitstream signal.

The invention may be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different distribution systems than those described above.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for modifying a bitstream signal bₓ for enabling collusion resistant bitstream watermarking, said method comprising:
dividing a bitstream spectral signal X[k] of said bitstream signal bₓ into a first signal and a second signal;
multiplying the first signal by a first modification signal and outputting a first modified signal;
performing a transform operation on said second signal for obtaining a transformed second signal;
multiplying said transformed second signal by a second modification signal and outputting a second modified signal;
subtracting said second modified signal from said first modified signal and outputting a modified bitstream spectral signal X′[k] suitable for obtaining a modified bitstream signal b′ₓ of said bitstream signal bₓ.

2. Method according to claim 1, wherein said transformation operation is a Hilbert transform operation.

3. Method according to claim 1, wherein said first modification signal (306) is
$$cos ( \frac{π}{N} ( 2 k + 1 ) τ ) .$$

4. Method according to claim 1, wherein said second modification signal (310) is
$$sin ( \frac{π}{N} ( 2 k + 1 ) τ ) .$$

5. Method according to claim 1, wherein said bitstream spectral signal X[k] is a priori watermarked using a bitstream watermarking technique, wherein said modified bitstream spectral signal X′[k] and said modified bitstream signal b′ₓ is a watermarked collusion resistant bitstream signal b_{y}.

6. Method according to claim 1, further comprising:
watermarking said modified bitstream signal b′ₓ of said modified bitstream spectral signal X′[k] using a bitstream watermarking technique producing a watermarked collusion resistant bitstream signal b_{y}.

7. A system for modifying a bitstream signal bₓ for enabling collusion resistant bitstream watermarking thereof, comprising:
means for dividing a bitstream spectral signal X[k] of said bitstream signal bₓ into a first signal and a second signal;
means for multiplying the first signal by a first modification signal and outputting a modified first signal;
means for performing a transform operation on said second signal for obtaining a transformed second signal;
means for multiplying said transformed second signal by a second modification signal and outputting a second modified signal;
means for subtracting said second modified signal from said first modified signal and outputting a modified bitstream spectral signal X′[k] suitable for obtaining a modified bitstream signal b′ₓ of said bitstream signal bₓ.

8. The system according to claim 7, further comprising:
means for watermarking the bitstream signal bₓ prior to the bitstream spectral signal being divided.

9. The system according to claim 7, further comprising:
means for watermarking said modified bitstream signal b′ₓ of said modified bitstream spectral signal X′[k].

10. A computer-readable medium having embodied thereon a computer program for modifying a bitstream signal bₓ for enabling collusion resistant bitstream watermarking, the computer program comprising:
a first code segment for dividing a bitstream spectral signal X[k] of said bitstream signal bₓ into a first signal and a second signal;
a second code segment for multiplying the first signal by a first modification signal and outputting a first modified signal;
a third code segment for performing a transform operation on said second signal for obtaining a transformed second signal;
a fourth code segment for multiplying said transformed second signal by a second modification signal and outputting a second modified signal;
a fifth code segment for subtracting said second modified signal from said first modified signal and outputting a modified bitstream spectral signal X′[k] suitable for obtaining a modified bitstream signal b′ₓ of said bitstream signal bₓ.

11. Use of the method according to claim 1 in an electronic music delivery system.
